(19) United States
(12) Patent Application Publication
(10) Pub. No.: US 2018/0269783 A1
(43) Pub. Date: Sep. 20, 2018

(54) DUAL-CHANNEL CONSTANT ON TIME SMPS WITH SINGLE PHASE-LOCKED LOOP AND THE METHOD THEREOF

(71) Applicant: Chengdu Monolithic Power Systems Co., Ltd., Chengdu (CN)

(72) Inventors: Qizhang Yin, San Jose, CA (US); Pengjie Lai, San Jose, CA (US); Chuntao Feng, Chengdu (CN)

(21) Appl. No.: 15/461,266

(22) Filed: Mar. 16, 2017

(51) Int. Cl. H02M 3/156

(52) U.S. Cl. CPC H02M 3/156

(57) ABSTRACT

A dual-channel constant on time SMPS with a phase-locked loop. The dual-channel constant on time SMPS effectively controls the phase shift between the two power switching circuits by generating a phase error signal based on the switching signals which are used to control the power switching circuits, the phase shift between the two power switching circuits is kept to a desired degree by regulating the second switching signal.

### FIELD

The present invention relates to electronic circuits, more specifically, relates to dual-channel constant on time switching mode power supply (SMPS) and the method thereof.

### BACKGROUND

Constant on time control scheme is widely used in SMPS due to fast output load transient response. But for a dual-channel SMPS with constant on time control, the phase shift between the first converter and the second converter is hard to control.

For traditional dual-channel constant on time SMPS, a clock generator and two phase-locked loops are commonly utilized to control the phase shift between the first converter and the second converter. The clock generator generates two clocks to be used as reference clocks, and the two phase-locked loops lock the phase of each converter with the reference clocks respectively.

However, each phase-locked loop requires a relative large die size, so a better method using a single phase-locked loop that can lock the phase shift between the two converters is desired.

### SUMMARY

A dual-channel constant on time SMPS with a single phase-locked loop is discussed. The dual-channel constant on time SMPS generates a phase error signal based on switching signals that are used to control the first converter and the second converter. The second converter can be regulated to track any desired phase shift from the first converter.

An embodiment of the present invention discloses a dual-channel constant on time SMPS, comprising: a first power switching circuit having an input terminal to receive an input voltage and an output terminal to provide a first output voltage, the first power switching circuit configured to operate under the control of a first switching signal; a first controller configured to generate the first switching signal; a second power switching circuit having an input terminal to receive an input voltage and an output terminal to provide a second output voltage, the second power switching circuit configured to operate under the control of a second switching signal; a phase-locked loop configured to generate a phase error signal based on the first switching signal and the second switching signal; and a second controller configured to generate the second switching signal; wherein the second switching signal is regulated to have a desired phase shift with the first switching signal by the phase error signal.

An embodiment of the present invention discloses a phase-locked loop configured to regulate a phase shift between a first power switching circuit and a second power switching circuit in a dual-channel constant on time SMPS, the first power switching circuit being controlled by a first switching signal, and the second power switching circuit being controlled by a second switching signal, the phase-locked loop comprises: a frequency detector configured to generate a phase signal based on the first switching signal and the second switching signal; a loop filter configured to filter the phase signal to a filtered signal; and a transconductance amplifier configured to generate a phase error signal based on the filtered signal and a third reference voltage, wherein the third reference voltage is proportional to a supply voltage.

An embodiment of the present invention discloses a method used in a dual-channel constant on time SMPS, the dual-channel constant on time SMPS comprising a first power switching circuit and a second power switching circuit, the method comprises: generating a first switching signal based on a first feedback signal indicative of the first output voltage to control the first power switching circuit; generating a second switching signal based on a second feedback signal indicative of the second output voltage to control the second power switching circuit; generating a phase error signal based on the first switching signal and the second switching signal; and regulating the second switching signal to have a phase shift of the desired degree with the first switching signal by the phase error signal.

### BRIEF DESCRIPTION OF THE DRAWINGS

FIG. 1 schematically shows a prior art dual-channel constant on time SMPS 100.

FIG. 2 schematically shows a dual-channel constant on time SMPS 200 in accordance with an embodiment of the present invention.

FIG. 3 schematically shows another dual-channel constant on time SMPS 300 in accordance with an embodiment of the present invention.

FIG. 4 schematically shows circuit configurations of a first controller 22, a second controller 24 and a phase-locked loop 25 in accordance with an embodiment of the present invention.

FIG. 5 schematically shows a circuit configuration of the phase-locked loop 25 in accordance with an embodiment of the present invention.

FIG. 6 shows a waveform diagram of signals in a dual-channel constant on time SMPS when the second switching signal PWM2 has a phase shift equal to the desired degree with the first switching signal PWM1 in accordance with an embodiment of the present invention.

FIG. 7 shows a waveform diagram of signals in a dual-channel constant on time SMPS about regulating the second switching signal PWM2 when the second switching signal PWM2 has a phase shift bigger than the desired degree with the first switching signal PWM1 in accordance with an embodiment of the present invention.

FIG. 8 shows a waveform diagram of signals in a dual-channel constant on time SMPS about regulating the second switching signal PWM2 when the second switching signal PWM2 has a phase shift smaller than the desired degree with the first switching signal PWM1 in accordance with an embodiment of the present invention.

FIG. 9 schematically shows a method 400 of controlling a dual-channel constant on time SMPS in accordance with an embodiment of the present invention.

The use of the similar reference label in different drawings indicates the same of like components.

### DETAILED DESCRIPTION

Embodiments of circuits for dual-channel constant on time SMPS are described in detail herein. In the following description, some specific details, such as example circuits for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

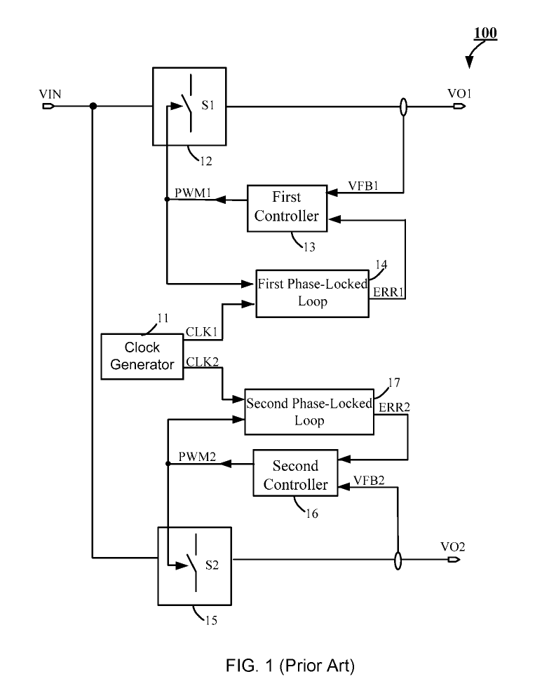

The FIG. 1 illustrates a prior art dual-channel constant on time SMPS 100. In FIG. 1 the dual-channel constant on time SMPS 100 comprises a clock generator 11, a first power switching circuit 12, a first controller 13, a first phase-locked loop 14, a second power switching circuit 15, a second controller 16 and a second phase-locked loop 17. The first power switching circuit 12 comprises a first switch S1 which is controlled by the first switching signal PWM1 while the second power switching circuit 15 comprises a second switch S2 which is controlled by the second switching signal PWM2. The clock generator 11 generates a first reference clock CLK1 to the first phase-locked loop 14 as a reference clock and a second reference clock CLK2 to the second phase-locked loop 17 as a reference signal. The phase difference between the first reference clock CLK1 and the second reference clock CLK2 is the desired phase shift between the two power switching circuits. The first switching signal PWM1 is regulated to have a phase shift of zero degree with the first reference clock CLK1 by a first error signal ERR1 through the first phase-Lock Loop 14, and the second switching signal PWM2 is regulated to have a phase shift of zero degree with the second reference clock CLK2 by a second error signal ERR2 through the second phase-locked loop 17. Since each phase-Lock Loop is a double pole system and requires separate compensation respectively that each phase-locked loop requires a lot of die size and thus the cost of a dual-channel constant on time SMPS with two phase-locked loops is relative high.

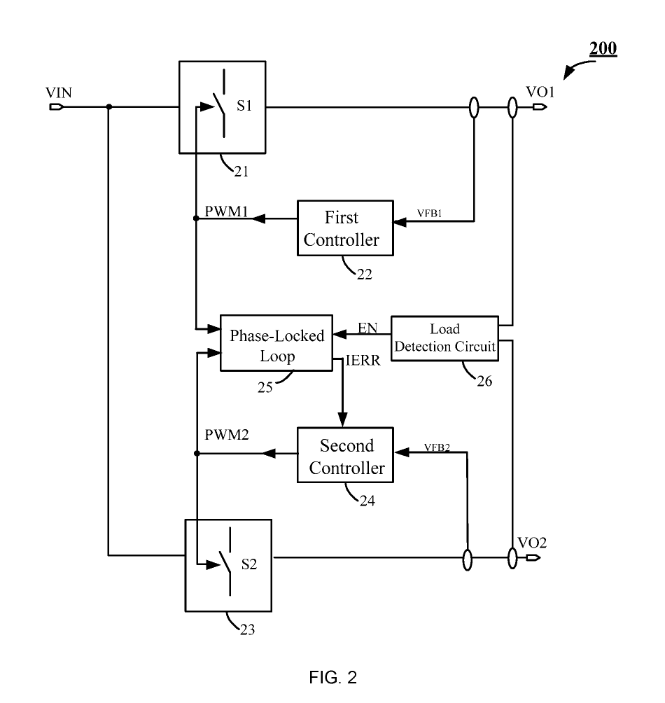

FIG. 2 schematically shows a dual-channel constant on time SMPS 200 in accordance with an embodiment of the present invention. In the example of the FIG. 2, the dual-channel constant on time SMPS 200 comprises a first power switching circuit 21, a first controller 22, a second power switching circuit 23, a second controller 24 and a phase-locked loop 25. The first power switching circuit 21 comprises an input terminal to receive an input voltage VIN, an output terminal to provide a first output voltage VO1, and a first switch S1 which is controlled by a first switching signal PWM1. The first controller 22 has an input terminal coupled to a first feedback signal VFB1 indicative of the first output voltage VO1, and an output terminal to generate the first switching signal PWM1. The second power switching circuit 23 comprises an input terminal to receive the input voltage VIN, an output terminal to provide a second output voltage V02, and a second switch S2 which is controlled by a second switching signal PWM2. The second controller 24 has an input terminal coupled to a second feedback signal VFB2 indicative of the second output voltage V02, and an output terminal to generate the second switching signal PWM2. The phase-locked loop 25 has a first input terminal coupled to the first switching signal PWM1, a second input terminal coupled to the second switching signal PWM2, and an output terminal to output a phase error signal IERR. The second switching signal PWM2 is regulated to achieve the desired phase shift with the first switching signal PWM1 by the phase error signal IERR through the phase-locked loop 25. When the second switching signal PWM2 has a phase shift bigger than the desired degree with the first switching signal PMW1, the phase error signal IEER is positive and the on time of the second switching signal PWM2 will be regulated to decrease. When the second switching signal PWM2 has a phase shift smaller than the desired degree with the first switching signal PWM1, the phase error signal IEER is negative and the on time of the second switching signal PWM2 will be regulated to increase. When the second switching signal PWM2 has a phase shift equal to the desired degree with the first switching signal PWM1, the phase error signal IEER is equal to zero.

The dual-channel constant on time SMPS 200 further comprises a load detection circuit 26. The load detection circuit 26 coupled to the first power switching circuit 21 and the second power switching circuit 23 for detecting the load information of the two power switching circuits and outputting an enable signal EN. The enable signal EN will disable the phase-locked loop 25 when either of the two power switching circuits is in light load.

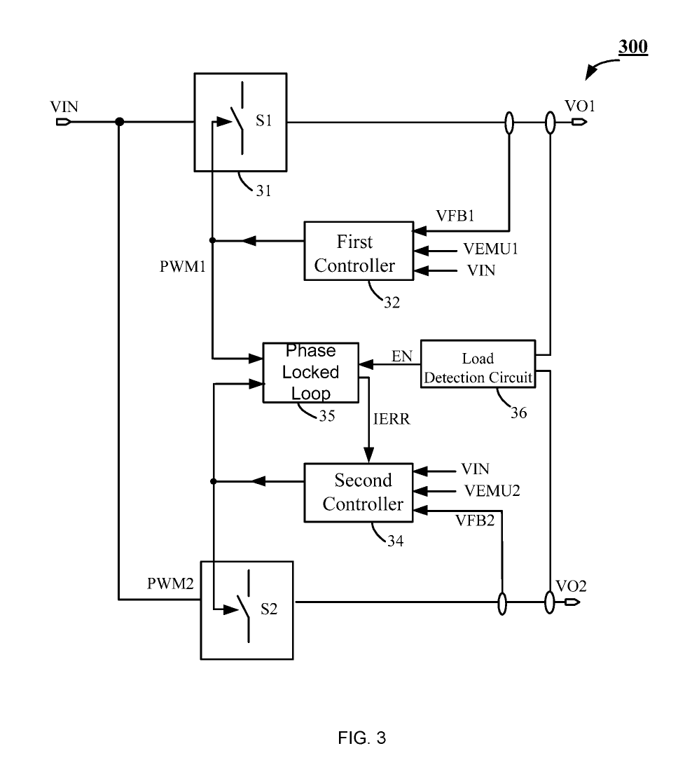

FIG. 3 schematically shows another dual-channel constant on time SMPS 300 in accordance with an embodiment of the present invention. Compared with the dual-channel constant on time SMPS 200 illustrated in the FIG. 2, a first controller 32 in the dual-channel constant on time SMPS 300 further has a second input terminal to receive a first emulation signal VEMU1 and a third input terminal to receive the input voltage VIN. The first controller 32 generates the first switching signal PWM1 based on the first feedback signal VFB1 indicative of the first output voltage VO1, the first emulation signal VEMU1 and the input voltage VIN. A second controller 34 also further has a second input terminal to receive a second emulation signal VEMU2 and a third input terminal to receive the input voltage VIN. The second controller 34 generates the second switching signal PWM2 based on the second feedback signal VFB2 indicative of the second output voltage V02, the second emulation signal VEMU2 and the input voltage VIN.

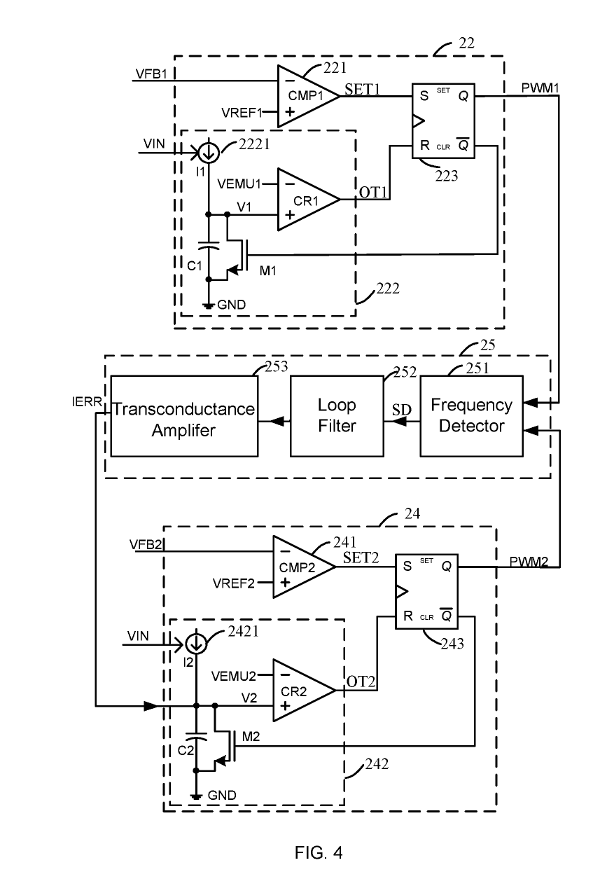

FIG. 4 schematically illustrates the first controller 22, the second controller 24 and the phase-locked loop 25 in accordance with an embodiment of the present invention. The first controller 22 comprises a first setting signal generator 221, a first on time determining circuit 222 and a first logic circuit 223. The first setting signal generator 221 has a first input terminal coupled to a first reference voltage VREF1, a second input terminal coupled to a first feedback signal VFB1 indicative of the first output voltage VO1, and an output terminal for providing a first setting signal SET1 based on the first reference voltage VREF1 and the first feedback signal VFB1.

The first on time determining circuit 222 comprises a first current source 2221, a first capacitor C1, a first switch M1 and a first comparator CR1, wherein the first current source 2221 provides a first current 11 to the first capacitor C1. In one embodiment, the first current 11 is constant. In another embodiment, the first current 11 is proportional to the input voltage VIN. The first comparator CR1 has a first input terminal coupled to a first emulation signal VEMU1, a second input terminal coupled to the first capacitor Cl to receive a first voltage V1, and an output terminal configured to generate a first on time signal OT1 by comparing the first emulation signal VEMU1 and the first voltage V1. In one embodiment, the first emulation signal VEMU1 has a constant value. In another embodiment, the first emulation signal VEMU1 is proportional to the first output voltage VO1.

The first logic circuit 223 has a first input terminal to receive the first setting signal SET1 and a second input terminal to receive the first on time signal OT1, and an output terminal for providing a first switching signal PWM1 based on the first setting signal SET1 and the first on time signal OT1 to the phase-locked loop 25.

The second controller 24 comprises a second setting signal generator 241, a second on time determining circuit 242 and a second logic circuit 243. The second setting signal generator 241 has a first input terminal coupled to a second reference voltage VREF2, a second input terminal coupled to a second feedback signal VFB2 indicative of the second output voltage V02, and an output terminal for providing a second setting signal SET2 based on the second reference voltage VREF2 and the second feedback signal VFB2.

The second on time determining circuit 242 comprises a second current source 2421, a second capacitor C2, a second switch M2 and a second comparator CR2, wherein the second current source 2421 provides a second current 12 to the second capacitor C2. In one embodiment, the second current 12 is constant. In another embodiment, the second current 12 is proportional to the input voltage VIN. The second on time determining circuit 242 further receives the phase error signal IERR to charge the second capacitor C2. When the second switching signal PWM2 has a phase shift bigger than the desired degree with the first switching signal PWM1, the phase error signal IERR is positive, and the on time of the second switching signal PWM2 is controlled to decrease. So the second switching signal PWM2 will be regulated back to have the desired phase shift with the first switching signal PWM1 after a plurality of cycles. When the second switching signal PWM2 has a phase shift smaller than the desired degree with the first switching signal PWM1, the phase error signal IERR is negative, and the on time of the second switching signal PWM2 is controlled to increase. The second switching signal PWM2 will be regulated back to have the desired phase shift with the first switching signal PWM1 after a plurality of cycles.

The second comparator CR2 has a first input terminal coupled to a second emulation signal VEMU2, a second input terminal coupled to a second voltage V2, and an output terminal configured to generate the second on time signal OT2 by comparing the second emulation signal VEMU2 and the second voltage V2. In one embodiment, the second emulation signal VEMU2 has a constant value. In another embodiment, the second emulation signal VEMU2 is proportional to the second output voltage V02.

The second logic circuit 243 has a first input terminal to receive the second setting signal SET2, a second input terminal to receive the second on time signal OT2, and an output terminal for providing a second switching signal PWM2 based on the second setting signal SET2 and the second on time signal OT2.

The phase-locked loop 25 comprises a frequency detector 251, a loop filter 252 and a transconductance amplifier 253. The frequency detector 251 has a first input end coupled to the first switching signal PWM1, a second input end coupled to the second switching signal PWM2, and an output end configured to provide a phase signal SD based on the first switching signal PWM1 and the second switching signal PWM2.

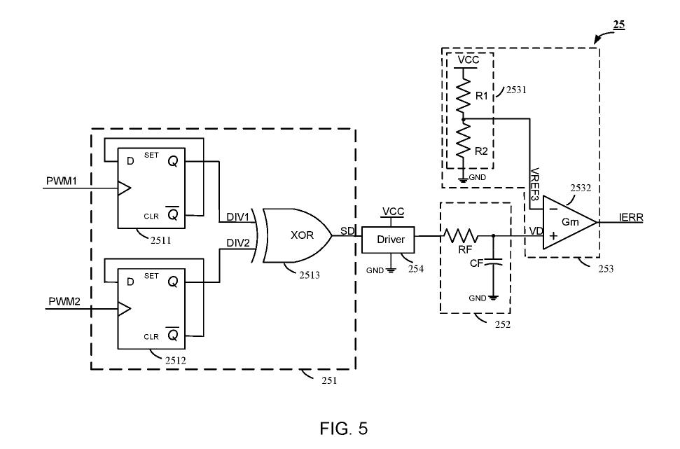

FIG. 5 schematically shows a circuit configuration of the phase-locked loop 25 in accordance with an embodiment of the present invention. The phase-locked loop 25 comprises a frequency detector 251, a loop filter 252 and a transconductance amplifier 253. The frequency detector 251 comprises a first frequency divider 2511, a second frequency divider 2512 and a XOR gate 2513. The first frequency divider 2511 receives the first switching signal PWM1 at an input end, and generates a first divided signal DIV1 based on the first switching signal PWM1 at an output end. The second frequency divider 2512 receives the second switching signal PWM2 at an input end, and generates a second divided signal DIV2 based on the second switching signal PWM2 at an output end. The XOR gate 2513 has a first end to receive the first divided signal DIV1 and a second end to receive the second divided signal DIV2 and an output end to provide the phase signal SD. The loop filter 252 is illustrated to comprise a filter resistor RF and a filter capacitor CF connected in series between the phase signal SD and a reference ground GND. A filtered signal VD is generated at the common connection of the filter resistor RF and the filter capacitor CF. The transconductance amplifier 253 has a positive input end, a negative input end and an output end, wherein the positive input end is coupled to the loop filter 252 to receive the filtered signal VD, the negative input end is coupled to a third reference signal VREF3, the transconductance amplifier 253 generates a phase error signal IERR based on the filtered signal VD and the third reference voltage VREF3. In one embodiment, the third reference voltage VREF3 comes from a feedback circuit 2531 as the FIG. 5 shown, the feedback circuit 2531 comprises a first resistor R1 and a second resistor R2 connected in series between a supply voltage VCC and the reference ground GND. The third reference voltage VREF3 is generated from the common connection of the first resistor R1 and the second resistor R2, wherein the desired phase shift determines the values of the first resistor R1 and the second resistor R2. For instance, if the desired phase shift is 180 degrees, the first resistor R1 and the second resistor R2 are equal and the third reference voltage VREF3 is equal to % *VCC. In one embodiment, the third reference voltage VREF3 is proportional to the supply voltage VCC. In one embodiment, the supply voltage VCC is used to provide power for the internal circuit of the converter. In other embodiment, the supply voltage VCC is equal to the input voltage VIN. In still other embodiment, the supply voltage VCC may have a value lower than the input voltage VIN, such as 5V or 3.3V for example.

The phase-locked loop 25 further comprises a driver 254 coupled the output end of the XOR gate 2513 to drive the loop filter 252, wherein the driver 254 is also coupled to the supply voltage VCC for power supply.

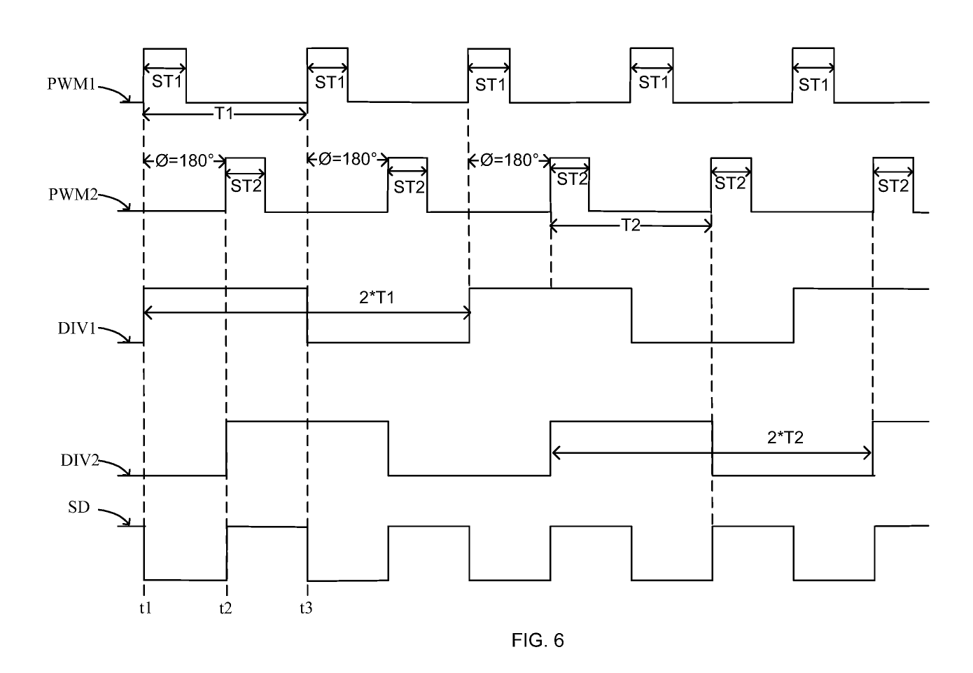

FIG. 6 shows a waveform diagram of signals in a dual-channel constant on time SMPS when the second switching signal PWM2 has a phase shift equal to the desired degree with the first switching signal PWM1 in accordance with an embodiment of the present invention. In the FIG. 6, the desired phase shift is setting to be 180 degrees. But one person in this art should understand that it just for example, the desired phase shift can be any other degree. FIG. 6 illustrates the first switching signal PWM1, the second switching signal PWM2, the first divided signal DIV1, the second divided signal DIV2 and the phase signal SD respectively. As the FIG. 6 shown, the first switching signal PWM1 is defined to have a period of T1, the on time of the first switching signal PWM1 is defined to be ST1, and the second switching signal PWM2 is defined to have a period of T2, the on time of the second switching signal PWM2 is defined to ST2. The first divider 2511 generates the first divided signal DIV1 with a period of 2* T1 based on the first switching signal PWM1, and the second divider 2512 generates the second divided signal DIV2 with a period of 2*T2 based on the second switching signal PWM2. The phase shift between the first switching signal PWM1 and the second switching signal PWM2 is defined to 0. At time t1, the first divided signal DIV1 transits from a first state to a second state at the trigger of the first rising edge of the first switching signal PWM1, and the first divided signal DIV1 keeps in the second state until the next rising edge of the first switching signal PWM1 comes. At time t3, the next rising edge of the first switching signal PWM1 comes and the first divided signal DIV1 transits from the second state to the first state. At time t2, the second divided signal DIV2 transits from a first state to a second state at the trigger of the rising edge of the second switching signal PWM2, and the second divided signal DIV2 keeps in the second state until the next rising edge of the second switching signal PWM2 comes. The phase signal SD is generated by a XOR operation of the first divided signal DIV1 and the second divided signal DIV2. For the second switching signal PWM2 keeps a phase shift of desired degree with the first switching signal PWM1, the phase signal SD has a duty cycle of 50%, thus the filtered signal VD is equal to % * VCC, and the phase error signal IERR is zero which are not shown in the FIG. 6.

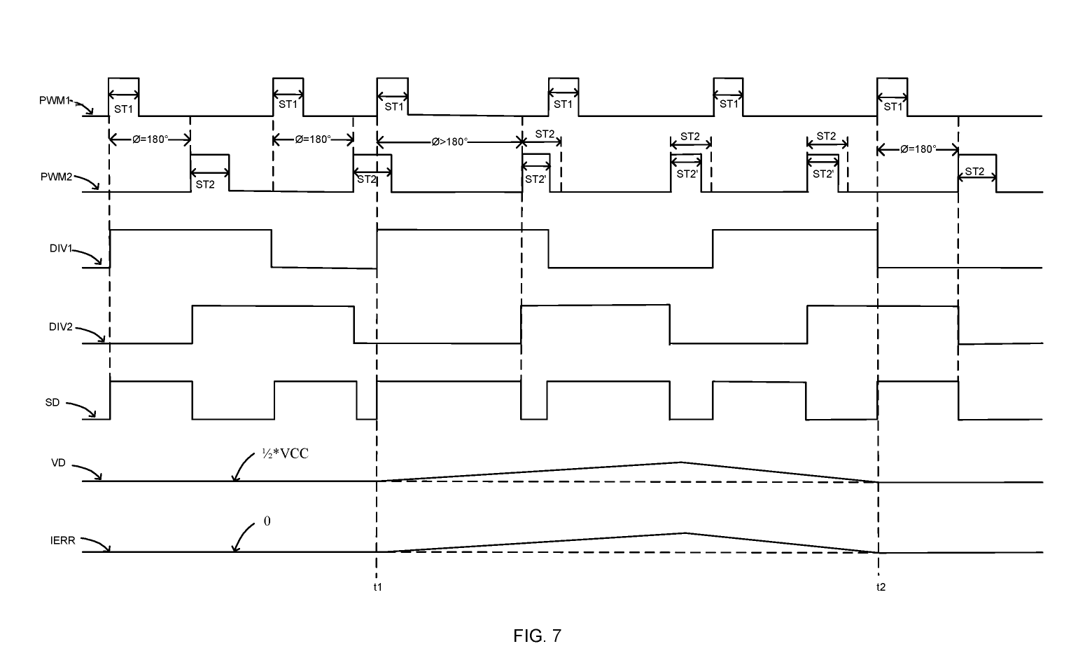

FIG. 7 gives an operating waveform of a dual-channel constant on time SMPS about regulating the second switching signal PWM2 when it has a phase shift bigger than 180 degrees with the first switching signal PWM1 according to an embodiment of the present invention. In the FIG. 6, the desired phase shift is setting to be 180 degrees. But one person in this art should understand that it just for example, the desired phase shift can be any other degree in other embodiment. FIG. 7 illustrates the first switching signal PWM1, the second switching signal PWM2, the first divided signal DIV1, the second divided signal DIV2, the phase signal SD, the filtered signal VD and the phase error signal IERR. Before time t1, for the second switching signal PWM2 keeps a phase shift of desired degree with the first switching signal PWM1, the phase signal SD has a duty cycle of 50%, thus the filtered signal VD is equal to ½*VCC, and the phase error signal IERR is zero. At time t1, some deviation happened to the first switching signal PWM1, the rising edge arrives at time t1, a little earlier than it predetermined time, thus the second switching signal PWM2 has a phase shift bigger than desired degree with the first switching signal PWM1 (Ø>180 degrees), the filtered signal VD increases from ½*VCC, and the phase error signal IERR increases from zero accordingly. This will cause the decreasing of the on time of the second switching signal PWM2, the on time of the second switching signal PWM2 is regulated from ST2 to ST2′ as the FIG. 7 shown, after several cycles of regulation, at time t2, the second switching signal PWM2 will be regulated back to have a phase shift of 180 degrees with the first switching signal PWM1. In the FIG. 7, the second switching signal PWM2 is regulated to back in 3 cycles. But one person in this art should understand that it just for illustration, in the real operation, a plurality of cycles are needed for regulating the second switching signal PWM2 back to have a phase shift of 180 degrees with the first switching signal PWM1.

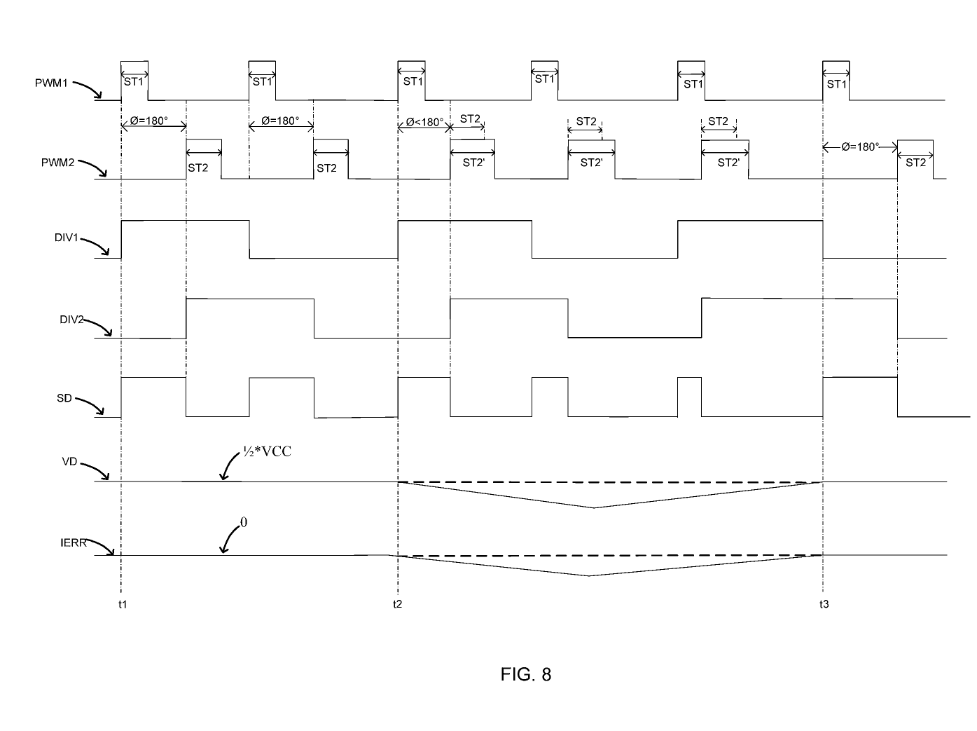

FIG. 8 gives an operating waveform of a dual-channel constant on time SMPS about regulating the second switching signal PWM2 when it has a phase shift smaller than desired degree according to an embodiment of the present invention. The filtered signal VD is 1/2 *VCC from time t1 to time t2 for the second switching signal PWM2 has a phase shift of 180 degrees with the first switching signal PWM1. At time t2, some deviation is happened on the first switching signal PWM1, the rising edge arrives at time t2, a little later than it predetermined time, thus the second switching signal PWM2 has a phase shift smaller than 180 degrees with the first switching signal PWM1 (Ø<180 degrees), the filtered signal VD decreases from ½*VCC and the phase error signal IERR decreases from zero accordingly. This will cause the increasing of the on time of the second switching signal PWM2, the on time of the second switching signal PWM2 is regulated from ST2 to ST2′ as the FIG. 8 shown, after several cycles of regulation, at time t3, the second switching signal PWM2 will be regulated back to have a phase shift of 180 degrees with the first switching signal PWM1. In the FIG. 8, the second switching signal PWM2 is regulated to back in 3 cycles. But one person in this art should understand that it just for illustration, in the real operation, a plurality of cycles are needed for regulating the second switching signal PWM2 back to have a phase shift of 180 degrees with the first switching signal PWM1.

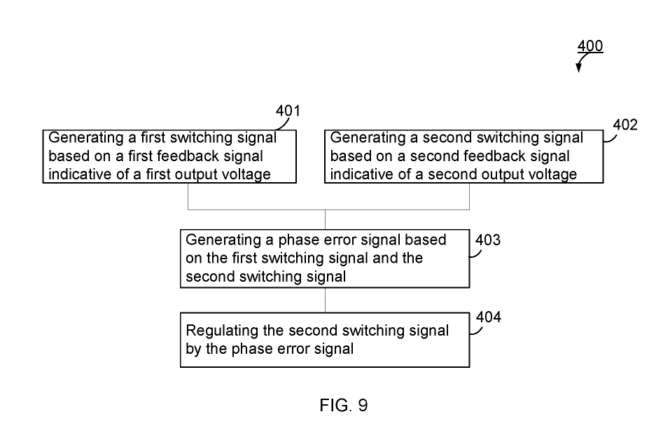

FIG. 9 schematically shows a method 400 of controlling a dual-channel constant on time SMPS in accordance with an embodiment of the present invention. The dual-channel constant on time SMPS comprise a first power switching circuit and a second power switching circuit, the method comprises:

Step 401, generating a first switching signal based on a first feedback signal indicative of a first output voltage to control the first power switching circuit.

Step 402, generating a second switching signal based on a second feedback signal indicative of a second output voltage to control the second power switching circuit.

Step 403, generating a phase error signal based on the first switching signal and the second switching signal.

Step 404, regulating the second switching signal to have a phase shift of desired degree with the first switching signal by the phase error signal.

In one embodiment, the phase error signal is a current signal. In another embodiment, the phase error signal is a voltage signal. In an embodiment, the regulation of the second switching signal comprises: when the second switching signal has a phase shift bigger than desired degree with the first switching signal, the phase error signal is positive; when the second switching signal has a phase shift smaller than desired degree with the first switching signal, the phase error signal is negative.

This written description uses examples to disclose the invention, including the best mode, and also to enable a person skilled in the art to make and use the invention. The patentable scope of the invention may include other examples that occur to those skilled in the art.

1. A dual-channel constant on time SMPS, comprising:
a first power switching circuit having an input terminal to receive an input voltage and an output terminal to provide a first output voltage, the first power switching circuit configured to operate under the control of a first switching signal;
a first controller configured to generate the first switching signal;
a second power switching circuit having an input terminal to receive an input voltage and an output terminal to provide a second output voltage, the second power switching circuit configured to operate under the control of a second switching signal;
a phase-locked loop configured to generate a phase error signal based on the first switching signal and the second switching signal; and
a second controller configured to generate the second switching signal;
wherein the second switching signal is regulated to have a desired phase shift with the first switching signal by the phase error signal.

2. The dual-channel constant on time SMPS of claim 1, wherein:
when the second switching signal has a phase shift bigger than the desired degree with the first switching signal, the phase error signal is positive; and
when the second switching signal has a phase shift smaller than the desired degree with the first switching signal, the phase error signal is negative.

3. The dual-channel constant on time SMPS of claim 1, further comprising:
a load detection circuit coupled to the first power switching circuit and the second power switching circuit for sensing the load information of the two power switching circuits and providing an enable signal, wherein the enable signal disables the phase-locked loop when either of the two power switching circuits is in light load.

4. The dual-channel constant on time SMPS of claim 1, wherein the second switching signal is regulated to have a phase shift of 180 degrees with the first switching signal by the phase error signal.

5. The dual-channel constant on time SMPS of claim 1, wherein the first controller is configured to generate the first switching signal based on the first feedback signal indicative of the first output voltage, the second controller is configured to generate the second switching signal based on the second feedback signal indicative of the second output voltage.

6. The dual-channel constant on time SMPS of claim 1, wherein the first controller is configured to generate the first switching signal based on the first feedback signal indicative of the first output voltage, the input voltage and a first emulation signal, the second controller is configured to generate the second switching signal based on the second feedback signal indicative of the second output voltage, the input voltage and a second emulation signal.

7. The dual-channel constant on time SMPS of claim 6,
Wherein the first controller comprises:
a first setting signal generator configured to generate a first setting signal based on a first reference voltage and the first feedback signal indicative of the first output voltage;
a first on time determining circuit configured to generate a first on time signal based on the input voltage and the first emulation signal; and
a first logic circuit configured to generate the first switching signal based on the first setting signal and the first on time signal;
and the second controller comprises:
a second setting signal generator configured to generate a second setting time signal based on a second reference voltage and the second feedback signal indicative of the second output voltage;
a second on time determining circuit configured to generate a second on time signal based on the input voltage, the second emulation signal and the phase error signal; and
a second logic circuit configured to generate the second switching signal based on the second setting signal and the second on time signal.

8. The dual-channel constant on time SMPS of claim 7, wherein the second on time determining circuit comprises:
a second current source configured to provide a second current;
a second capacitor and a second switch, coupled in parallel, wherein the second capacitor is charged by the second current and the phase error signal when the second switch is OFF;
a second comparator configured to generate the second on time signal by comparing the second emulation signal with a voltage across the second capacitor.

9. The dual-channel constant on time SMPS of claim 1, wherein the phase-locked loop comprises:
a frequency detector configured to generate a phase signal based on the first switching signal and the second switching signal;
a loop filter configured to filter the phase signal to a filtered signal; and
a transconductance amplifier configured to generate the phase error signal based on the filtered signal and a third reference voltage, wherein the third reference voltage is proportional to a supply voltage.

10. The dual-channel constant on time SMPS of claim 9, wherein the frequency detector comprises:
a first frequency divider having an input end to receive the first switching signal and an output end to provide a first divided signal based on the first switching signal;
a second frequency divider having an input end to receive the second switching signal and an output end to provide a second divided signal based on the second switching signal; and
a XOR gate having a first input end to receive the first divided signal, a second input end to receive the second divided signal, and an output end to provide the phase signal.

11. The dual-channel constant on time SMPS of claim 9, wherein the loop filter comprises:
a filter resistor having a first end and a second end, the first end coupled to the frequency detector to receive the phase signal; and
a filter capacitor having a first end coupled to the second end of the filter resistor, and a second end coupled to a reference ground.

12. The dual-channel constant on time SMPS of claim 9, wherein the transconductance amplifier having a first input end coupled to the third reference signal, a second input end coupled to the loop filter to receive the filtered signal, and an output end to provide the phase error signal.

13. The dual-channel constant on time SMPS of claim 9, wherein the loop filter further comprises a driver coupled to the supply voltage for driving the loop filter.

14. A phase-locked loop, configured to regulate a phase shift between a first power switching circuit and a second power switching circuit in a dual-channel constant on time SMPS, the first power switching circuit being controlled by a first switching signal, and the second power switching circuit being controlled by a second switching signal, the phase-locked loop comprises:
a frequency detector configured to generate a phase signal based on the first switching signal and the second switching signal;
a loop filter configured to filter the phase signal to a filtered signal; and
a transconductance amplifier configured to generate a phase error signal based on the filtered signal and a third reference voltage, wherein the third reference voltage is proportional to a supply voltage.

15. The phase-locked loop of claim 14, wherein the frequency detector comprises:
a first frequency divider having an input end to receive the first switching signal and an output end to provide a first divided signal based on the first switching signal;
a second frequency divider having an input end to receive the second switching signal and an output end to provide a second divided signal based on the second switching signal; and
a XOR gate having a first input end to receive the first divided signal, a second input end to receive the second divided signal, and an output end to provide the phase signal.

16. The phase-locked loop of claim 14, wherein the loop filter comprises:
a filter resistor having a first end and a second end, the first end coupled to the frequency detector to receive the phase signal; and
a filter capacitor having a first end coupled to the second end of the filter resistor, and a second end coupled to a reference ground.

17. The phase-locked loop of claim 14, wherein the transconductance amplifier has a first input end coupled to the third reference signal, a second input end coupled to the loop filter to receive the phase signal, and an output end to provide the phase error signal.

18. A method used in a dual-channel constant on time SMPS, the dual-channel constant on time SMPS comprising a first power switching circuit and a second power switching circuit, the method comprises:
generating a first switching signal based on a first feedback signal indicative of the first output voltage to control the first power switching circuit;
generating a second switching signal based on a second feedback signal indicative of the second output voltage to control the second power switching circuit;
generating a phase error signal based on the first switching signal and the second switching signal; and
regulating the second switching signal to have a phase shift of the desired degree with the first switching signal by the phase error signal.

19. The method of claim 18, wherein the regulating of the second switching signal comprises:
when the second switching signal has a phase shift bigger than the desired degree with the first switching signal, the phase error signal is positive; and
when the second switching signal has a phase shift smaller than the desired degree with the first switching signal, the phase error signal is negative.

20. The method of claim 18, wherein regulating the second switching signal to have a phase shift of 180 degrees with the first switching signal by the phase error signal.
